(19) United States
(12) Patent Application Publication
(10) Pub. No.: US 2007/0105977 A1
(43) Pub. Date: May 10, 2007

(54) Kneadable Hand Putty as a Delivery System for Skin Conditioning and/or Thermal Therapy Agents

(76) Inventors: Gregory Bruce Gabriel, Los Altos, CA (US); Don Ricardo Ford, Chino, CA (US); David Muth Hadden, Los Altos, CA (US)

Correspondence Address: GLENN PATENT GROUP, 3475 EDISON WAY, SUITE L, MENLO PARK, CA, 94025, US

(21) Appl. No.: 11/558,877

(22) Filed: Nov. 10, 2006

Related U.S. Application Data
(60) Provisional application No. 60/747,358, filed on May 16, 2006.
(60) Provisional application No. 60/735,297, filed on Nov. 10, 2005.

(51) Int. Cl. C08L 91/06

(52) U.S. Cl. 523/122; 106/271

(57) ABSTRACT

A kneadable putty-like material that is used as a delivery system to deliver skin conditioning agents, and/or essential oils, and/or medicinal agents, and/or antimicrobial agents, and/or thermal therapy agents to the surface of the skin, in particular to the hands, in appropriate concentrations, is disclosed.

### CROSS REFERENCE TO RELATED APPLICATIONS

This application claims priority to U.S. provisional patent application Ser. Nos. 60/747,358, filed 16 May 2006 and 60/735,297, filed 10 Nov. 2005, each of which is incorporated herein in its entirety by this reference thereto.

### BACKGROUND OF THE INVENTION

1. Techincal Field

The invention relates to putty, such as a kneadable material or deformable solid, into which is incorporated any of skin conditioning agents, such as emollients, humectants; moisturizers; moisture barriers and the like; and thermal therapy agents, with the putty acting as a delivery system for the incorporated agents to the surface of the skin.

2. Description of the Related Art

Skin conditioning

Skin conditioning agents, such as emollients, humectants, moisturizers, moisture barriers, etc., are typically applied to the surface of the skin in the form of liquids, lotions, creams, or ointments. Emollients, such as petrolatum, and moisture barriers, such as dimethicone, function primarily as occlusive barriers to prevent water loss from the external skin layers, thus enhancing moisture retention in the skin.

While many effective and economical skin conditioning products are available, they nevertheless suffer from certain disadvantages in some situations and applications. In particular, when skin conditioning agents are applied to the hands in the form of liquids, lotions, creams, or ointments, they often leave an unpleasant or unwanted feeling on the skin, such that the hands feel slippery, oily, greasy, or the like. As a result, an inordinate amount of hand rubbing or working-in of these materials to eliminate the slippery feeling is required. Additionally, it is often necessary to wipe off excessive material with a paper or fabric towel.

Silicone elastomer putties, also known as bouncing putties, are described in the patent literature in, for example, U.S. Pat. No. 2,431,878 (McGregor, Dec. 12, 1947); U.S. Pat. No. 2,541,851 (Wright, Feb. 13, 1951); U.S. Pat. No. 3,350,344 (Beers, Oct. 31, 1967); U.S. Pat. No. 3,677,997 (Kaiser, Jul. 18, 1972); U.S. Pat. No. 4,371,493 (Minuto, Feb. 1, 1983); U.S. Pat. No. 5,319.021 (Christy, Jun. 7, 1994); and U.S. Pat. No. 5,607,993 (Christy, Mar. 4, 1997)] and in the silicone industry literature, e.g. R. R. McGregor: Silicones and Their Uses, McGraw-Hill (1954) pp. 186-187.

The related prior art describes compositions and methods for making silicone elastomer putties with certain material properties, such as coherence, elasticity, plasticity, and density. Related prior art also describes compositions and methods for reducing tackiness, also known as stickiness, and stiffness.

U.S. Pat. No. 3,677,997 (Kaiser Jul. 18, 1972), in the introduction, mentions additives such as “fillers, aromatics, pigments, dyes” as well as “medicaments and anti-bacterial agents.” The fifth and final claim states: “The bouncing putty of claim 1 also containing one or more of antibiotics, disinfectants and fillers.” There is no mention or teaching of using the putty as a delivery vehicle for medicaments or antibiotics, etc., and it appears that the Kaiser '997. patent concerns the addition of antibiotics and disinfectants to the putty to keep the putty free from microbial contaminants.

U.S. Pat. No. 5,607,993 (Christy Mar. 4, 1997) concerns the addition of additives to a bouncing putty base to make it lighter in weight (less dense) and, further, to make this less-dense putty softer (less viscous), less sticky, and less oily.

U.S. Pat. No. 5,472,994 (Micallef, Dec. 5, 1995), Microwave-Heatable Exercise Putty, concerns an exercise putty that may be heated in a microwave oven.

Kaiser, U.S. Pat. No. 3,677,997 states that “the products of this invention employ the siloxane polymers, boron compounds, and known additives . . . and are prepared by the methods previously known and employed in the art. The additives, including fillers, aromatics, pigments, dyes soluble in the system, and the defined polyglycols are added in any desired sequence. The fillers include fume silicas, titanias, barium sulfate, diatomaceous earth, and other known pulverulent materials so used.”

U.S. Pat. No. 4,551,332 (Stillman, Nov. 5, 1985) and U.S. Pat. No. 4,664,914 (Stillman, May 12, 1987) concern, respectively, vitamin E compositions and methods, and jojoba oil compositions and methods, and refer in the text and claims to dermatological coating materials, protective coatings, Vaseline® substitutes, dermatological putties, and carriers of germicidal or therapeutic agents. The term putty is used in the sense of a coating material or poultice.

U.S. Pat. No. 4,650,665 (Kronenthal, Mar. 17, 1987) describes a biologically compatible putty-like composition or matrix for administering active agents in the body over time.

U.S. Pat. No. 6,679,918 (Benedict, Jan. 20, 2004) describes compositions for an implantable putty material for delivery of active compounds to a patient.

U.S. Pat. No. 6,391,941 B1 (Williams May 21, 2002) describes a therapeutic putty for hand exercising, including a polysiloxane-boron compound including an antimicrobial agent to make the compound resistant to the growth of microbes within the compound. Thus, the Williams' patent concerns the addition of antimicrobial agents to the putty to keep the putty free from microbial contaminants.

U.S. Pat. No. 6,747,115 B2 (Sakuta, Jun. 8, 2004) describes a silicone polymer paste-like composition forming a cosmetic material.

Thermal Therapy

Heating and cooling regions of the body are common therapies. Heating therapy is used for relaxation, reduction of lower back pain, arthritis pain, etc. Cooling therapy is used to reduce itching, swelling, inflammation of bug bites, pain, trauma from sports injuries, bruising after surgery, etc.

In 1990, the United States Sports Academy Sports Medicine Laboratory studied soft tissues and optimal healing temperatures for prolonged cryotherapy. Their findings revealed that the optimum healing temperature for prolonged cold therapy application is between 7° C. and 12° C.

Phase change materials (PCMs) cannot absorb as much heat as ice packs, but are available in the preferred cold therapy range of 7-12° C. (Table 1). This limitation is offset by a lower loss of cooling potential to the ambient air temperature because the differential between the ambient and the PCM is less than the differential between the ambient and 0° C. ice.

TABLE 1

| Carbon | | Formula | Melting | Boiling | CAS |
|---|---|---|---|---|---|
| Number | Name | Molecular Wt. | Point | Point | RN |
| C(8) | n-Octane | C₈H₁₈ (114.23) | −57 C./−70.6 F. | 126 C./258.8 F. | 111-65-9 |
| C(10) | n-Decane | C₁₀H₂₂ (142.28) | −30 C./−22 F. | 174 C./345.2 F. | 124-18-5 |
| C(12) | n-Dodecane | C₁₂H₂₆ (170.34) | −9.5 C./14.9 F. | 216 C./420.8 F. | 112-40-3 |
| C(14) | n-Tetradecane | C₁₄H₃₀ (198.39) | 6 C./42.8 F. | 254 C./489.2 F. | 629-59-4 |
| C(16) | n-Hexadecane | C₁₆H₃₄ (226.44) | 18 C./64.4 F. | 287 C./548.6 F. | 544-76-3 |
| C(18) | n-Octadecane | C₁₈H₃₈ (254.50) | 28 C./82.4 F. | 316 C./600.8 F. | 593-45-3 |
| C(20) | n-Eicosane | C₂₀H₄₂ (282.55) | 37 C./98.6 F. | 343 C./649.4 F. | 112-95-8 |
| C(22) | n-Docosane | C₂₂H₄₆ (310.61) | 44.5 C./112.1 F. | 368.5 C./695.3 F. | 629-97-0 |
| C(24) | n-Tetracosane | C₂₄H₅₀ (338.66) | 52 C./125.6 F. | 391 C./735.8 F. | 646-31-1 |

Optimal temperatures for thermotherapy have also been studied. Some guidelines available from published experimental studies are shown in Table 2

TABLE 2

| Authors | Temperature range | Effects |
|---|---|---|
| Lehman and deLateur | 40° C. to 45° | “therapeutic effects” |
| (1982)¹ | | |
| Kanui (1987)² | 38° C. to 42° C. | “substantial analgesia” |
| Lehman and deLateur | 40° C. to 45° C. | reduces muscle spasm |
| (1982)² | | |
| Lehman (1971)³ | 41° C. | produces minimal change |
| | | in circulation |
| Lehman (1971)⁴ | 45° C. | produces maximal change |
| | | in circulation |
| Hardy (1951)⁴ and | 44.5° C. +/− 1.3° C. | pain is elicited |
| Stevens (1983)⁵ | | |
| Hardy (1951)⁵ and | 46° C. to 47° C. | skin damage occurs |
| Stevens (1983)⁶ | | |

¹Lehman J F and deLateur B J (1982). Therapeutic Heat. In J F Lehman (ed). Therapeutic Heat and Cold, 3rd ed. Williams and Wilkins, Baltimore.
²Kanui T I (1987). Thermal alleviation of capsaiclin chemogenic pain. Pain Supplement, 1-4, S 50.
³Lehman J F (1971). Diathermy. In F H Krusen, F J Kottke, Elwood J (eds). Handbook of Physical Medicine and Rehabilitation. W B Saunders, Philadelphia.
⁴Hardy J D (1951). Influence of skin temperature upon pain threshold evoked by thermal irradiation. Science, 114, 149-150.
⁵Stevens J (1983). Thermal sensation: Infra-red and microwaves. In E Adair (ed). Microwaves and thermal regulation. Academic press, London.

Therapeutic heat is applied using several common methods such as hot water bottles, electric heating pads, infrared lamps, gel heat packs, microwavable flannel bags containing natural flax or other seeds.

Therapeutic wax treatments are also used to apply heat. For example, the hand or foot is placed in a liquid paraffin bath and withdrawn when a thin layer of warm solid paraffin forms, becomes adherent, and covers the skin. The dipping procedure is repeated until a thick paraffin glove is formed. The heat can be retained by wrapping with towels for 20 minutes. Then, the cool solid paraffin glove is peeled away and the paraffin is recycled. The dip method is a mild heat application because only a limited amount of heat is available for transfer to the skin. While this method is effective, it is messy, uses a potentially flammable wax, and it can be difficult to apply for treatment to all parts of the body.

In some cases, heat or cold is delivered to the body part using a pump to maintain continuous circulation of water from a temperature-controlled insulated reservoir through a tube to a flexible bladder which is in contact or surrounds the area requiring attention. An advantage of this system is that temperatures of the bladder in contact with the body part can be held constant for long periods of time and, using a heater or cooling element, can be adjusted to almost any desired temperature. A disadvantage is that these systems are bulky, expensive and not conveniently portable.

There are numerous products and methods that can deliver either heat or cold. They can be as simple as hot towels for heat to ice cubes in a Ziploc® bag for cold. More complex heating therapy methods can include shortwave diathermy, microwaves, and ultrasound. Cold therapy can involve the application of liquid nitrogen to the skin to remove precancerous skin moles, nodules, skin tags, or unsightly freckles.

One of the most common commercially available cooling therapy products is a gel ice pouch. The pouch can be made of any flexible material. PVC is a popular material, but is becoming less so because of environmental concerns. To produce more durable bags and keep costs down, some companies are using a combination of materials, including PE, EVA, PU, nylon, and cloth.

A gel ice pouch often contains water plus USDA and/or FDA approved ingredients, such as water and food-grade cellulose gum, such as carboxyl methyl cellulose (CMC), which is also used to make fruit jelly. The purpose of CMC is to thicken the solution to control leakage in the event that a pouch is punctured. To prepare for use, these pouches are frozen solid in a home freezer.

When water is heated or cooled at any temperature other than 0° C. or 100° C., it takes one calorie of heat per gram of water to increase its temperature 1° C. This is called sensible heat. That is, when heat energy is added, it causes a measurable temperature increase. If one calorie of heat is removed from one gram of water, its temperature is decreased by one degree Celsius. The specific heat of a substance is defined as the amount of heat, measured in calories, required to raise the temperature of one gram of a substance by one degree Celsius.

When water is in the form of ice at exactly 0° C., it is necessary to add 80 calories of heat to each gram of water to cause it to completely change to liquid at 0° C. This is called the latent heat of melting. The heat energy transfer required to change state from a liquid to a solid is called the latent heat of fusion. Different materials have different latent heats, but water has one of the highest latent heats for the state change between solid and liquid.

Upon melting and freezing, per unit weight, materials known as phase change materials (PCM's) absorb and release substantially more energy than a sensible heat storage material that is heated or cooled over the same temperature range. Water is the most common PCM. In contrast to sensible heat storage, wherein a material absorbs and releases energy essentially uniformly over a broad temperature range, a phase change material absorbs and releases a large quantity of energy in the vicinity of its melting/freezing point.

For example, in PCM's the amount of energy absorbed upon melting or released upon freezing for a given quantity of material is much greater than the amount of energy absorbed or released upon increasing or decreasing the temperature of the material over an increment of ten degrees that does not include the PCM's melting or freezing temperature.

The use of PCM's for thermal storage has long been known. One of the earliest known applications of this principle is the use of ice as a thermal storage medium for perishable foods. In addition to solid-to-liquid or liquid-to-gas phase changes, certain materials exhibit solid-to-solid phase changes. Another subgroup of PCM's uses reversible exothermic reactions, such as hydration-dehydration or solution-precipitation reactions, for heat storage. The latent heat of phase change can be used for heating or cooling depending on whether the phase change is exothermic or endothermic. In most materials the phase changes are reversible so that the latent heat storage can be used for either heating or cooling depending on the temperature conditions.

To make pouches flexible at freezing temperatures so they conform to a body part, a food grade propylene glycol (PG) or salt is mixed with water and the gelling agent. While this keeps the pouch pliable below the freezing point of water it also modifies the phase change properties of the mixture, depending on the ratio of PG to water. The result is that the mixture does not completely change phase at 0° C. and therefore does not provide as much cooling capacity as it would otherwise provide. The trade-off is container flexibility for heat absorption capacity.

As an example, consider the following: Assume a pound of water and a pound of a mixture containing 20% PG and 80% water are both cooled to −5° C. It takes more heat energy to raise the pound of pure water to 5° C. than it does to raise the 20/80 mixture to 5° C. The limitation of water as a PCM is that its solid-to-liquid phase change temperature is too cold to be conveniently used for cryotherapy. Cold packs can only be applied for a few minutes at a time and must then be removed to prevent tissue damage. Ice packs also gather condensation because the dew point of air around them is seldom below freezing.

There are many materials that exhibit phase change and they do so over a wide range of temperatures with a wide range of latent heat capacities. Examples are hydrated salts including calcium chloride hexahydrate, sodium sulphate decahydrate and sodium acetate trihydrate, and modified varieties covering a range of transition temperatures about 8° C. to 58° C. Calcium chloride hexahydrate has a melting point of 29° C. and specific heat of 46 cal/g. Waxes, such as those listed in Table 1 also exhibit phase change and they do so over a wide range of temperatures with a wide range of latent heat capacities. A typical wax might have a melting point of 64° C. and a specific heat of 41 cal/g.

### SUMMARY OF THE INVENTION

Accordingly, one aspect of the invention is to provide a delivery system for skin conditioning agents that overcomes some of the disadvantages inherent in traditional delivery systems, resulting in desirable skin-feel properties.

Another aspect of the invention is to provide sufficient but not excessive skin conditioning agents to the surface of the skin.

Another aspect of the invention is to provide a delivery system for skin conditioning agents that can be handled without risk of spilling or staining.

Another aspect of the invention is that it can be used as a delivery vehicle for topically applied medicinal agents and/or antimicrobial agents to the hands or other surfaces of the skin.

Another aspect of the invention is that it is compatible with a variety of essential oils and fragrances and can be used as a passive (let it stand) or active (knead or press it) delivery system to the surface of the skin or ambient air for fragrances or perfumes.

The delivery system of the invention can pertain to, individually or in combination, but is not limited to, skin conditioning agents, essential oils, medicinal agents, antimicrobial agents, fragrances, and coloring agents.

Another aspect of the invention is that it can be used as hand exercise putty, while at the same time providing skin conditioning benefits and/or medical benefit. The hardness, or stiffness, of the putty material can be modified by changing the relative proportion of ingredients, using different filler materials or viscosity-modifying additives, or by temperature (heating or cooling the material).

The invention preferably comprises a kneadable putty-like material that is used as a delivery system to deliver skin conditioning agents, and/or essential oils, and/or medicinal agents, and/or antimicrobial agents, and/or thermal therapy agents to the surface of the skin, in particular to the hands, in appropriate concentrations.

Putty-like materials with kinematic viscosity in a range between 800K and 1,600K centistokes are usable. A more preferred range is between 1,000K and 1,400K centistokes.

The putty-like delivery system can be based on silicone, vinyl, cellulose, or any other putty-like formulations or combinations thereof, into which the agents desired to be delivered are either miscible or can be blended within the putty matrix in a range that provides for an appropriate amount of the desired agent or agents, either individually or in combination, to be delivered to the skin.

Agents that can be delivered to the skin by this delivery system include, but are not limited to, skin conditioning agents, essential oils, medicinal agents, antimicrobial agents, fragrances, and coloring agents.

In a preferred embodiment of the invention, the putty-like delivery system is comprised of a base of polydimethylsiloxane polymers. For skin conditioning applications, additional ingredients might include, individually or in various combinations, but are not limited to, petrolatum, dimethicone, aloe juice, shea butter, glycerin, etc.

An alternative embodiment of the invention comprises a putty-like delivery system for which incorporates thermal agents for use in connection with thermal therapy.

### BRIEF DESCRIPTION OF THE DRAWINGS

FIG. 1 shows a simplified theoretical time/temperature curve for a material at 54° C. with a phase change temperature of 42° C. that is allowed to cool in a non-circulating water bath at 4.5° C. according to the invention;

FIG. 2 shows the relative rates of change of temperatures of a 50-gram sample of silicone gum only compared to another 50-gram sample containing 34 grams of gum and 16 grams of a PCM according to the invention;

FIG. 3 is a photograph which shows that the putty according to the invention can be intimately conformed to even the most irregularly shaped body part and its general shape formed as required;

FIG. 4 is a photograph which shows that viscosity of the putty according to the invention can be adjusted depending on the application;

FIG. 5 is a photograph which shows that the putty according to the invention has natural conforming tendencies which cause it to stay in place;

FIG. 6 is a photograph which shows a putty according to the invention which cures into a flexible but fixed shape. This can be achieved with appropriate catalysts that, when mixed into the putty or when mixed in and heated to the appropriate temperature, cause the putty to cure into the desired; and

FIG. 7 is a photograph which shows a silicone-based putty according to the invention with a heat activation catalyst that can be flash-cured on the outside using a flame so that the outer layer of the putty becomes a container.

### DETAILED DESCRIPTION OF THE INVENTION

Skin Conditioning

One presently preferred embodiment of the invention provides a deformable solid or putty-based delivery system for delivery of skin-conditioning agents that overcomes disadvantages inherent in traditional delivery systems, resulting in desirable skin-feel properties.

An example of a putty-based delivery system is a putty-like material, capable of being kneaded by a human hand, comprising a gum elastomer and an additive or additives selected from a group including, for example, skin conditioners, essential oils, medicinal agents, antimicrobial agents, and fragrances. When the gum elastomer is kneaded by the human hand, the additive or additives are released to the hand or other skin surface against which the putty is pressed. Preferably, the putty-like material includes a gum elastomer having a low hardness to facilitate kneading by the human hand. The putty-like material optionally has a low hardness, in the Shore 00 range, or viscosity over a range of resistances suitable for use as a hand exercise putty.

The putty-like material optionally includes any of a number of components. The putty-like material preferably includes a gum elastomer that includes one or more of, for example, styrene butadiene rubber, styrene ethylene butylenes rubber, silicone, polyisobutylenes, ethylene vinyl acetate, ethylene propylene rubber, ethylene propylene diene monomer rubber, polybutadiene rubber, natural rubber, polyisoprene rubber, butyl rubber, fluorocarbon rubber, and polyurethane. Additional gum elastomers include any of SBR, SEBR, silicone, PIB, EVA, EPR, EPDM, and polyurethane. Preferably, the putty-like material includes one or more additives. Optional additives include any of, but are not limited to, a fragrance, such as a phenol and an emollient. Preferably, the putty-like material includes a reinforcing filler, where the reinforcing filler is preferably one or more of talc, silica, clay, and a fine particle mineral filler, such as a nanoparticle. Optionally, the putty-like material further includes a viscosity modifying agent. Optional viscosity modifying agents include one or more of mineral oil, modified mineral oil, sulfonated mineral oil, silicone oil, phosphates, sebacates, and paraffinic oil, such as phthalates. Optionally, the putty-like material includes a plasticizer. The portion of gum elastomer, additives, and reinforcing filler, viscosity agent, and plasticizer are each individually variable.

The putty-like material delivers a contained or dissolved component to skin via contact, which is induced or enhanced by kneading or rubbing.

Examples of the invention include:
A kneadable putty-like material used as a delivery system for skin conditioners, emollients, moisturizers, and/or moisture barrier agents to the skin. An example of kneadable putty includes a polysiloxane-boron compound, such as a bouncing putty, which exhibits sufficient elasticity to be kneaded or squeezed resulting in release of the skin conditioning contents.
A kneadable putty-like material used as a delivery system optionally including any of an essential oil, fragrance, antibacterial agent, and/or sunscreen.
A kneadable putty-like material used as a delivery system for such agents as petrolatum, dimethicone, shea butter, glycerin, lanolin, other emollients, moisturizers, and/or moisture barriers or related compounds in an appropriate concentration to the skin.
A kneadable putty-like delivery system based on elastic polymers of silicone, vinyl, cellulose, or other putty-like chemistry or combinations thereof into which the desired agents to be delivered are either miscible or are blended within the putty matrix in a range that delivers an appropriate quantity of desired agent or agents, either individually or in combination to the hand or skin upon contact, rubbing, or kneading.
A putty-like delivery system where the putty-like base materials possess kinematic viscosity in a range between about 800K and 1,600K centistokes. A more preferred range is between about 1,000K and 1,400K centistokes.
A putty-like delivery system as described supra, further including a filler material to increase the viscosity, wherein the filler material is present in the amount of from about 1% by weight to about 60% by weight based on 100% by weight of said composition.
A putty-like delivery system as described supra, wherein filler material includes any of silica, talc, calcium carbonate, wood flour, titanium dioxide, cotton flock, clay, bentonite, zinc hydroxide, barium sulfate, and/or combinations thereof.
A putty-like delivery system containing microspheres.
A putty-like delivery system as described supra, further including a softener material to decrease the viscosity of the putty-like composition, wherein the softener is present in the amount of about 1% by weight to about 30% by weight based on 100% by weight of said composition.
A putty-like delivery system as described supra, wherein the softener material includes any of oleic acid, silicone oils, glyceryl oleate, glycerol oleate, and combinations thereof.
A putty-like delivery system as described supra, wherein a softener or viscosity reducing agent includes a moisture scavenger.
A putty-like delivery system as described supra, where the active agents, such as petrolatum, dimethicone, shea butter, glycerin, lanolin and other emollients, moisturizers, and moisture barriers are present without the inactive ingredients or diluents normally found in lotions, creams and liquids, thereby resulting in delivery of a large quantity of active agent within a small volume of putty-like material.
A putty-like delivery system as described supra, where the system is designed to deliver a specific quantity of the desired agent or agents to the skin. The putty delivers the desired agents as the user continuously or intermittently squeezes it in her hands or rubs it on her skin. The amount of the desired agent or agents delivered is based on an equilibrium point reached between the concentration of desired agent in the putty and the concentration of the agent on the skin.
A putty-like delivery system as described supra, where the active agent or agents are preferably depleted versus the depletion of the putty carrier as the putty is squeezed or rubbed on the user's skin. The amount of active agent required by the skin is only a small fraction of the total amount of agent suspended or dissolved in the putty. The change in the total percent concentration of agent in the putty is only reduced by a small percentage with each use.
A putty-like delivery system as described supra, where the active agent or agents are depleted as the putty is squeezed or rubbed on the user's skin, while the putty carrier is not depleted.
A putty-like delivery system as described supra, where the putty is chewable and delivers an additive orally.
A putty-like delivery system as described supra, where the putty delivers a narrow range of product per hand/squeeze cycle, such as about 1 to 500 micrograms of product or additive per hand squeeze cycle or about 200 to 300 micrograms of product per hand/squeeze cycle.
A putty-like delivery system as described supra, where the putty acts as a planarizer adding material to a rough surface to make it more level.
A putty-like delivery system as described supra, where the putty acts as a stain remover.
A putty-like delivery system as described supra, where the putty incorporates thermal therapy agents, as discussed in greater detail below.

Another aspect of the invention provides sufficient but not excessive skin conditioning agents to the surface of the skin.

In yet another aspect of the invention, a delivery system for skin conditioning agents is provided that is handled without risk of spilling or staining.

In still another aspect of the invention, putty is used as a delivery vehicle for topically applied medicinal agents and/or antimicrobial agents to the hands or other surfaces of the skin.

In another aspect of the invention, putty is used to deliver essential oils, individually or in combination. The essential oils are delivered via the putty in a passive manner by letting the base material stand and/or in an active manner, through mechanisms such as kneadin or pressing the putty.

In another aspect of the invention, putty is used to deliver a variety of compatible fragrances. The fragrances and/or perfumes are delivered via the putty in a passive manner by letting the base material stand and/or in an active manner, through mechanisms such as kneading or pressing the putty.

The delivery of components of the invention optionally includes, but is not limited to, skin conditioning agents, essential oils, medicinal agents, antimicrobial agents, fragrances, and/or coloring agents. The components are delivered individually or in combination.

Another aspect of the invention is use as hand exercise putty, while at the same time providing skin-conditioning benefits and/or medical benefit. The hardness, or stiffness, of the putty material is optionally modified by changing the relative proportion of ingredients, using different additives or filler materials, or by temperature control, such as heating or cooling the material for a period of time.

In yet another aspect of the invention, a kneadable putty-like material is used as a delivery system to deliver skin conditioning agents, and/or essential oils, and/or medicinal agents, and/or antimicrobial agents to the surface of the skin, in particular to the hands, in appropriate concentration.

Putty-like delivery system where the putty-like base materials possess kinematic viscosity in a range between about 800K and 1,600K centistokes. A more preferred range is between about 1,000K and 1,400K centistokes. The putty-like delivery system is optionally based on silicone, vinyl, cellulose, and/or any other putty-like formulations or combinations thereof, into which the agents desired to be delivered are either miscible or are blended within the putty matrix in a range that provides for an appropriate amount of the desired agent or agents, either individually or in combination, to be delivered to the skin.

Agents that are delivered to the skin by this delivery system include, but are not limited to, skin conditioning agents, essential oils, medicinal agents, antimicrobial agents, fragrances, and coloring agents.

In still yet another embodiment of the invention, the putty-like delivery system is comprised of a base of polydimethylsiloxane polymer. For skin conditioning applications, additional ingredients optionally include, but are not limited to petrolatum, dimethicone, aloe juice, shea butter, glycerin, and the like. The skin conditioning agents are optionally used individually or in combination.

In yet another embodiment of the invention, the color of the putty is correlated with the use of the putty. For example, a first color is used for a skin conditioner and a second color is used for a cleaner. For example, a green color or a nourishing color is used for a skin conditioner while a gray color or dark color, which is beneficial in hiding dirt, is used as a hand cleaner. Additional colors are used or associated with additional uses.

Permutations, combinations, and/or obvious variants of the aspects of the invention, embodiments of the invention, elements of the putty, and examples of use are also regarded as part of the invention.

Kneadable hand putty is not limited to bouncing putty or exercise putty or therapeutic hand putty. Other applications include: stress reduction, play, cosmetic applications, aroma therapy, etc.

A preferable/specific base material is a polysiloxane-boron compound, such as Q2-3233 bouncing putty base from Dow Corning.

Example formulae to yield a kneadable hand putty are provided in Table 3 below.

TABLE 3

| | Parts by | | Parts by | | Parts by | |
|---|---|---|---|---|---|---|
| Material | weight | Percent | weight | Percent | weight | Percent |
| Q2-3233 | 100.00 | 83.00 | 100.00 | 71.00 | 100.00 | 64.00 |
| SF96-50 | 10.00 | 8.00 | 20.00 | 14.00 | 30.00 | 19.00 |
| Silopren U 10 | 5.00 | 4.00 | 10.00 | 7.00 | 15.00 | 10.00 |
| Q4-2737 | 3.00 | 3.00 | 3.00 | 2.00 | 3.00 | 2.00 |
| Petrolatum | 2.00 | 2.00 | 8.50 | 6.00 | 8.50 | 5.00 |
| Total | 120.00 | 100.00 | 141.50 | 100.00 | 156.50 | 100.00 |

1. Q2-3233 - borosilicone rubber base bouncing putty (Dow Corning)
2. SF96-50 - dimethicone silicone fluid viscosity modifier (GE Silicones)
3. Silopren U10 - cyclomethicone silicone fluid viscosity modifier (GE Silicones)
4. Q4-2737 - silicone fluid stabilizer (Dow Corning)
5. Petrolatum - viscosity modifier, lubricating agent

The above formulae produce easily kneadable hand putties. Within the formula ranges, incremental variations in the percentages of the viscosity modifying agents result in slightly harder or softer putties.

Q4-2737 acts a stabilizing agent so that the putty maintains the same consistency over time.

Dimethicone (SF96-60) and petrolatum also act as emollients and moisture barrier agents on the skin.

The middle formula above is a preferable formula for the invention in that it results in an easily kneadable hand putty that, when squeezed or kneaded, releases small (not excessive) amounts of dimethicone and petrolatum which act as emollients on the skin. The release characteristics are unique, in that continued squeezing or kneading of the putty does not result in increased release of emollients onto the skin. The skin does not become oily or greasy. Instead, an equilibrium state is reached whereby continued kneading acts to work the emollient material back into the putty, leaving only a thin layer of emollient material deposited on the skin.

This equilibrium effect also occurs when the putty is used as a delivery vehicle for aromatic agents, such as essential oils and natural and synthetic fragrances; and for topical medications such as aloe vera juice, menthol, camphor, and capsaicin.

Example formula of putty including an aromatic agent are provided in Table 4 below.

TABLE 4

| | Parts by | |
|---|---|---|
| Material | weight | Percent |
| Q2-3233 | 100.00 | 70.50 |
| SF96-50 | 20.00 | 14.10 |
| Silopren U 10 | 10.00 | 7.10 |
| Q4-2737 | 3.00 | 2.10 |
| Petrolatum | 8.50 | 6.00 |
| Fragrance (green apple) | 0.25 | 0.20 |
| Total | 141.75 | 100.00 |

Example formula of putty including a topical medication such as aloe vera juice 5 are provided in Table 5.

TABLE 5

| | Parts by | |
|---|---|---|
| Material | weight | Percent |
| Q2-3233 | 100.00 | 69.00 |
| SF96-50 | 20.00 | 14.00 |
| Silopren U 10 | 10.00 | 7.00 |
| Q4-2737 | 3.00 | 2.00 |
| Vaseline | 8.50 | 6.00 |
| Aloe vera juice | 2.89 | 2.00 |
| Total | 144.39 | 100.00 |

Evidence of the moisture barrier effect can be seen by rinsing the hands in water after only a few squeezes of the putty. The water beads up and runs off the skin where it has been contact with the putty.

In a series of squeeze tests involving eight individuals, a 50.0 gram-amount of putty for each person was squeezed twenty times, alternating between both hands, over a period of one minute. The hands were then washed in soap and water to remove any emollient material, then dried with a paper towel before repeating twenty squeezes per minute. The squeeze-wash-dry cycle was repeated for up to 5,000 squeezes. After each 1,000 squeezes the putty was weighed. The average decrease in putty weight at the end of 1,000 squeezes was 2.12%. The average decrease at the end of 5,000 squeezes was 5.78%. At the end of the test, i.e. after 5,000 squeezes, the emollient feel of the putty, although diminished, was still noticeable, and the moisture barrier effect when the hands were rinsed in water was still evident.

Typically, color is added to the putty. Although the addition of color is not essential, the following provides a typical formula including pigments. Certain colors and scents pair well together, e.g. light green with an apple scent, light purple with lavender scent (see Table 6 below).

TABLE 6

| | Parts by | |
|---|---|---|
| Material | weight | Percent |
| Q2-3233 | 100.00 | 70.50 |
| SF96-50 | 20.00 | 14.10 |
| M10 CST/Silopren U 10 | 10.00 | 7.10 |
| Q4-2737 | 3.00 | 2.10 |
| Petrolatum | 8.50 | 6.00 |
| Pigment - CR50 White | 0.17 | 0.10 |
| Pigment - FP1007 Green | 0.17 | 0.10 |
| Total | 141.84 | 100.00 |

Thermal Therapy

To accomplish therapeutic heating or cooling to various parts of the body, the delivery system must be able to deliver or remove heat at the proper rate and temperature for an appropriate length of time. It must also be convenient and easy to use. To accomplish this, the following must be taken into consideration.
Efficiency of the thermal path between the body part and the material that is providing the heating and cooling;
Heating or cooling capacity of the delivery system;
Maintenance of the optimum heating or cooling temperature;
Optimum rate of heat being infused or removed;
Portability; and
Ease of use.

All of these issues can be addressed using a high viscosity matrix material into which various substances can be mixed that impart the desired characteristics. One favored matrix material is a high-viscosity silicone gum, such as Shincor Silicones KE-76-BSR.

Different PCM's can be used to provide high heating or cooling capacity at various desired temperatures. A PCM can be microencapsulated to create a PCM power. The encapsulated particles must be compatible when mixed in with the silicone putty carrier and not release/activate upon the pressure of squeezing, and be robust enough to survive numerous cycles of solidification and liquefaction (volume changes) during the intended use. Encapsulation shell materials, such as SARAN, VTAC and styrene butadiene can be used. Wax PCM's can be melted and prilled to form particles which are then coated using spray or fluid bed coating technology to create a uniform layer of material on the particle surface

Hydrated salt PCM materials are water soluble, so the capsule shell is applied via a non-aqueous coating system, such as fluid bed coating with a Wurster system. The typical shell materials described above and many others can be used. Again, the capsule shell should be durable enough to withstand repeated phase changes and incorporation into the matrix.

The resulting encapsulated particles can be made of a size that is optimum for the application when used in concert with other materials added to the matrix. Generally, particles in the 10 to 250 micron range are used. The method of encapsulation and the PCM materials encapsulated must be designed so they are not damaged during dispersion into a high viscosity, e.g. 1-million to 2-million centipoise, matrix material.

The primary purpose of the matrix material is as a binder to hold or contain all of the substances needed to give the needed viscosity and thermal properties to the matrix. Viscosities can be designed to increase or decrease with temperature for applications discussed later. Silicone gum is one of many desirable materials because it does not support bacterial growth, is chemically inert, non-toxic if ingested, and is well tolerated by the skin. Many other matrix materials, such as kraton polymers and plasticine clays, can also be used. Silicone gum is used only as a preferred example.

Silicone gum as a matrix material can be formulated to give the desired rheology outcome when it contains all of the fully dispersed component materials needed to make an efficient putty-like mass that can be used to infuse or remove heat to a body part. The completed matrix with all additives is referred to as a putty. Silicone gums typically have a low specific heat, e.g. around 0.5, and no phase change within the normal range of therapeutic temperatures, so it is desirable to use as low a percentage of this material as possible.

The thermal and electrical conductivity of the putty-like mass also needs to be adjusted to give maximum performance. Materials such as graphite, aluminum, or iron oxide powder can be used for both electrical and thermal conductivity, but other materials can also be used. Electrical conductivity is important if the putty is to be heated in a microwave oven. Heating times in microwave ovens can be adjusted depending on the amount, size, and type of conductive substance added to the putty. It is desirable that the heating time is long enough that it can easily be varied in small increments. That is, a heating time of 30-60 seconds is preferred to one of 5-10 seconds.

Particle sizes for aluminum or graphite are generally in the 10-250 micron range. The quantity of electrically and thermally materials required depends on the thermal and electrical conductivity of the microencapsulated PCM's used.

The rate of heat transfer is determined by the thermal conductivity of the material through which heat is being transferred, the length of the path, and the temperature on each side of the path through which heat is passing. The thermal conductivity of the putty can be adjusted to optimize the heat transfer rate and temperature from within the mass to the surface in which it is contacted for a given shape and thickness of putty, phase change temperature, and latent heat capacity. The thermal characteristics and temperature of whatever the putty is placed in contact with has a measurable influence on the transfer rate. For this reason, various putty compositions can be blended, depending on where the putty is to be applied and the type of heat or cold therapy being used.

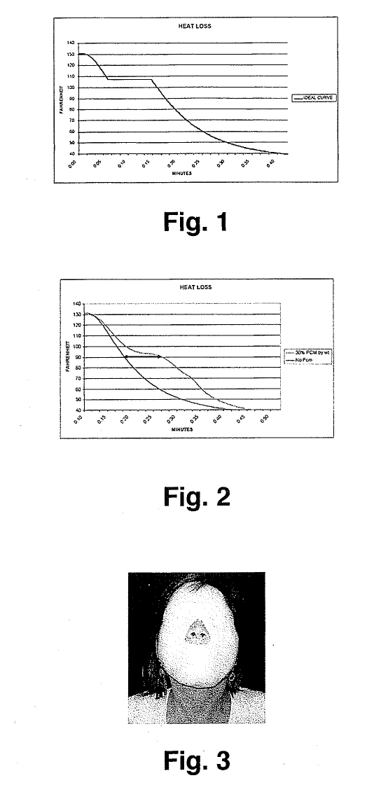

FIG. 1 shows a simplified theoretical time/temperature curve for a material at 54° C. with a phase change temperature of 42° C. that is allowed to cool in a non-circulating water bath at 4.5° C.

FIG. 2 shows the relative rates of change of temperatures of a 50-gram sample of silicone gum only compared to another 50-gram sample containing 34 grams of gum and 16 grams of a PCM. The PCM was a microencapsulated wax with a nominal particle size of 40 microns, a phase change temperature of about 35° C., and a heat of fusion of about 41 calories/g.

Each sample was pressed into a 100 cc Pyrex beaker, forming a cylindrical mass about 40-mm in diameter and 34-mm high. The beaker was covered. Thermocouples were placed in the geometric center of each mass in the beakers. The two beakers were simultaneously heated in a non-circulating 54° C. water bath until thermal equilibrium was reached. The two beakers were then plunged into a non-circulating cold water bath at 4.5° C. and the two temperatures recorded.

FIG. 2 shows the increased length of time at elevated temperature caused by the addition of the PCM. The temperature during phase transition is not constant in FIG. 2 because of a wide-cut paraffin mix of different molecular weights and, as the test sample began freezing, the rate of heat dissipation was not constant. Narrow-cut or pure paraffins are not required to produce the desired results. A higher concentration of PCMs would extend the time that the putty remains within the 35° C. temperature range while cooling.

It is also possible to use microencapsulation systems, wherein the microcapsules are broken as the putty is kneaded. By selecting appropriate materials to add to the matrix and to microencapsulate, either endothermic or exothermic reactions can be made to take place as microcapsules are broken, thus making the putty self-heating or self-cooling. When kneaded by hand, only those particles which are subject to a critical level of shear breaks. As a result, the amount of heat or cold released is a function of the vigor with which the putty is squeezed.

It is also possible to use other microencapsulation systems, wherein the microcapsules are broken as the putty is kneaded. By selecting appropriate materials to add to the matrix and to microencapsulate, the putty can be used as a delivery system for perfumes, aromas, and other volatiles such as camphor, peppermint, or eucalyptus oils, etc. When kneaded by hand, only those particles which are subject to a critical level of shear break. The result is that the amount of volatiles released can be controlled by the vigor with which the putty is squeezed.

Once all of the capsules have been broken, no more heat or cold can be generated from within the putty but, if PCMs and electrically conductive materials have also been included, the putty can be externally heated or cooled. Another advantage of using PCMs within this structure is that highly endothermic or exothermic reactions can be used and the heat absorption or loss can be stored within the PCMs within the putty, rather than drastically increasing or decreasing the sensible heat of the putty should no PCMs be present. Without PCMs, the putty could get too hot or cold for use. That is, the heat loss or gain until the putty reached therapeutic temperature levels would be lost.

Table 7 shows a comparison of the heat content of two different putty mixtures, one with no PCM's and the other with the addition of 30% by weight of a PCM with the characteristics. Note that the addition of PCM increased the heat content by a factor of 2.6.

TABLE 7

| 30% PCM | | 0% PCM | |
|---|---|---|---|
| ***INPUTS*** | | ***INPUTS*** | |
| grams wax | 10.0 | grams wax | — |
| grams silicone gum | 20.0 | grams silicone gum | 30.0 |
| Average specific heat | 0.7 | Average specific heat | 0.7 |
| of paraffin(0.7 cal/ | | of paraffin(0.7 cal/ | |
| degree F./gram) | | degree F./gram) | |
| heat of fusion wax | 50.0 | heat of fusion wax | 25.2 |
| 40-60 cal/gram | | 40-60 cal/gram | |
| Average specific heat | 0.50 | Average specific heat | 0.50 |
| of silicone putty | | of silicone putty | |
| Beginning temperature | 120.0 | Beginning temperature | 120.0 |
| Ending tempreature | 98.0 | Ending tempreature | 98.0 |
| ***OUTPUTS*** | | ***OUTPUTS*** | |
| grams total wt | 30 | grams total wt | 30 |
| heat content of wax | 654 | heat content of wax | 0 |
| heat content of | 220 | heat content of | 330 |
| silicone putty | 874 | silicone putty | 330 |
| heat content of mixture | 874 | heat content of mixture | 330 |
| Heat content | 2.65 | Heat content | 1.00 |
| ratio(wax and silicone)/ | | ratio(wax and silicone)/ | |
| (silicone only) | | (silicone only) | |

In one embodiment the putty can be used in direct contact with a body part for infusing or removing heat as a therapy rather than being contained a pouch, bag, etc.

An advantage is that the material can be intimately conformed to even the most irregularly shaped body part and its general shape formed as required. See FIG. 3.

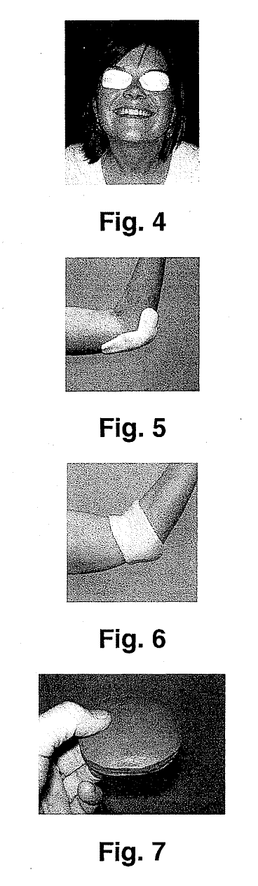

Another advantage is that viscosity of the putty can be adjusted depending on the application. This is especially important when it is desirable to apply heating or cooling therapy the face, and especially delicate body parts, such as eyelids. See FIG. 4.

Another advantage is that the putty can be blended, such that its viscosity is softer when it is warm and becomes stiffer as it cools. A user can heat the putty in a microwave and begin squeezing it while it is warm. This not only imparts heat to the hand, which is an important therapy for arthritis sufferers, but it is easier to squeeze while the hand is loosening up. As the user continues to squeeze, the putty cools off and becomes stiffer as the hand warms up. This makes it a desirable enhancement over existing hand therapy putties such as those sold under the name Thera-Putty® which are only available in various discrete viscosities and cannot be heated in a microwave because they contain no electrically conductive component.

Another advantage of applying the putty directly to a body part is that the putty can also be infused or mixed with antibacterial agents, aromas, emollients, conditioners, oils, capsaicin, menthol, and many other additives that are released during application of heat or cold.

Another advantage of the putty is that its natural conforming tendencies cause it to stay in place. See FIG. 5. This is a particular advantage for putty used over the eyes during facial treatments. Certain silicone gums such as Shincor Silicones KE-76-BSR have a naturally adhesive property when in contact with a surface and tend stay in place when pressed against a body or other part. While this gum feels slightly sticky, it leaves no residue. In some applications, no other securing mechanism is required.

Another advantage is that the putty can be mixed with microencapsulated ingredients that cause either endothermic or exothermic reactions when encapsulation shells are broken during kneading by the user, the rate of reaction being controlled by the vigor of kneading. By including PCM's, unwanted sensible heat can be reduced.

In another embodiment, either pure silicone gum or gum mixed with sparkles, dyes, or other additives to make the putty attractive to small children can be placed in the refrigerator or a thermos cup and used for small injuries, such as bumps and bruises. The putty has both a cooling and calming effect and offers a parent something simple but positive action to take on behalf of the child while helping distract the child from a minor injury. When a child suffers a minor injury, the putty is removed from the cooling device and place over the injury.

In another embodiment, putty such as a silicone gum putty can be created with all of the characteristics and additives discussed above, but can also include a catalyst so that it can be cured. That is, either by making the putty as two components, such that when mixed together at room temperature, the mixture cures into a flexible but fixed shape, or as a single component system with appropriate catalysts that, when heated to the appropriate temperature, can be cured. See FIG. 6.

Another advantage is that flexible custom heating or cooling appliances can be created that hold their shape. Such shapes or applications are not restricted to therapy or medical applications. Such shapes could be in the form of heat-retaining trivets for serving dishes, wraps for hot or cold drinks, etc. Because putties can be blended either to heat or not heat in a microwave oven, it is possible to make a composite material wherein two layers of putty are laminated. The bottom layer contains no electrically conductive material or PCM's. The top layer contains both PCMs and electrically conductive material. If the conductive layer is about 3 cm thick and the bottom layer about 1 cm thick, and the composite made circular, it could become a combination dish heater and hot pad because it could be heated in the microwave with the top layer absorbing heat, while the bottom layer would not heat and would act as an insulator. Materials can be added to the bottom layer to enhance its insulative properties. This is only one example to illustrate how the subject putty can be used.

In another embodiment, the putty can be used within a pouch, bag, etc., as is done with existing gels. Because the putty generally has more viscosity than current cooling gels, it is safe to put it in pouches having very thin walls made of materials, such as multi-layer cast stretch films similar to those supplied by Intertape Polymer Group. Pouches can be made from many other materials including polyethylene, PVC, flexible urethane, etc. At high viscosities, the putty can even be contained in cloth bags made from materials such as nylon or polyester or tight weave cotton blends.

In another embodiment, a silicone-based putty with a heat activation catalyst can be flash-cured on the outside using a flame so that the outer layer of the putty becomes the container. See FIG. 7. The thickness of the outer layer is determined by the heat and duration of the flame. The same thing can be accomplished by any method causing the outer surface of the mass to reach the cure temperature quickly, thus reducing the depth to which curing takes place. An advantage is that sealed containers of any shape can be created and still have the flexibility to conform to the body part or area of concern in question.

In another embodiment, the putty can be used within a pouch, bag, etc., as is done with existing gels, to which a layer of insulative material such as Ethafoam® polyethylene foam or Insulite® closed-cell expanded polyvinyl chloride can be bonded to one side of the pouch to decrease heat or gain loss on the side of the pouch opposite where heating or cooling is desired.

In another embodiment, a pouch can be created between an insulating foam layer and a pouch containing the putty. An endothermic or exothermic material can be activated and placed in this pouch, thus heating the putty. As described earlier, rather large amounts of heating or cooling can be generated and used to change the phase of a PCM mixed into the putty rather than causing an undesirable amount of sensible heating or cooling which makes the putty too hot or cold to be therapeutic and is thus lost.

In other embodiments, various straps, belts, webs, or other attaching means can be incorporated with any combination of putty only, putty in a pouch, putty in a pouch with insulative backing, or putty only applied against an insulative backing, putty with a pouch of exothermic or endothermic material placed directly on the putty which can be activated, putty in a pouch with a pouch of exothermic or endothermic material laminated directly to the putty pouch which can be activated, putty in a pouch with insulative backing with a pouch between the insulative layer and the putty layer into which a pouch of exothermic or endothermic material can be placed and activated or activated before placement in said pouch with said attachment means to hold the putty, insulation, endothermic, or exothermic materials, in any combination, into position against the body or any other object where it is desirable to impart the addition or removal of heat or delivery of any other substance that can be delivered using any combination of embodiments described herein.

In another embodiment, each of the various putty systems described above are kept in an insulated container to retain heat or cold for extended periods where no microwave or refrigeration is available, such as a sporting event, bicycle trip.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A kneadable additive delivery mechanism, comprising:
a putty-like material having a consistency making it kneadable by a human hand, said putty-like material comprising a delivery vehicle for at least one additive; and
at least one additive dispersed within said putty-like material, said additive comprising any of an emollient, an aromatic including essential oils and fragrances, a medicinal agent, and an antimicrobial agent;
wherein when said putty-like material is kneaded by a human hand the additive is released in a buffered or equilibrated manner to any of the hand, other skin surfaces, surfaces against which the putty is pressed, or to the ambient air.

2. The putty-like material of claim 1, said putty-like material comprising a base material selected from the group consisting of styrene butadiene rubber, styrene ethylene butylene rubber, silicone, polyisobutylenes, ethylene vinyl acetate, ethylene propylene rubber, ethylene propylene diene monomer rubber, polybutadiene rubber, natural rubber, polyisoprene rubber, butyl rubber, fluorocarbon rubber, polyurethane, and waxes.

3. The putty-like material of claim 1, said additive comprising a viscosity-modifying additive comprising any of dimethicone and petrolatum, said viscosity-modifying additive also comprising any of an emollient and moisture barrier agent.

4. The putty-like material of claim 1, said additive comprising 1% to 30% by weight of an emollient or combination of emollients.

5. The putty-like material of claim 1, said additive comprising an emollient selected from the group including, but not limited to, dimethicones, petrolatum, mineral oil, glycerin, shea butter, olive oil, coconut oil, lanolin, cocoa butter, cetyl alcohol, jojoba oil, and thermal agents comprising PCMs.

6. The putty-like material of claim 1, said additive comprising 0.1% to 10%, and preferably 0.2% to 5%, by weight of aromatic agents, individually or in combination.

7. The putty-like material of claim 6, wherein the aromatic agents are selected from the group including, but not limited to, essential oils, and natural and synthetic fragrances.

8. The putty-like material of claim 1, said additive comprising 0.01% to 10% by weight of topical medications, individually or in combination.

9. The putty-like material of claim 8, wherein the topical medications are selected from the group including, but not limited to, aloe vera juice, menthol, camphor, cajuput oil, clove oil, and capsaicin.

10. The putty-like material of claim 1, said additive comprising 0.1% to 3% by weight of an antimicrobial agent in sufficient concentration to impart an antimicrobial effect to the hands or the part of the skin to which it is applied by a person kneading the material.

11. The putty-like material of claim 10, wherein the antimicrobial agent comprises triclosan.

12. A putty-like material, capable of being kneaded by a human hand, comprising:
a gum elastomer; and
at least one additive selected from the group consisting of skin conditioners, essential oils, medicinal agents, antimicrobial agents, fragrances, and thermal agents comprising PCMs;
wherein when the gum elastomer is kneaded by a human's hand the additive is released to the hand or other skin surface against which the material is pressed.

13. The putty-like material of claim 12, wherein the gum elastomer has a low hardness to facilitate kneading by the human hand.

14. The putty-like material of claim 13, wherein the Shore 00 hardness of the material ranges from 1 to 60, and preferably from 3 to 30, to provide a suitable range of resistances when the material is also to used as a hand exercise putty.

15. The putty-like material of claim 12, wherein the gum elastomer is selected from the group consisting of styrene butadiene rubber, styrene ethylene butylenes rubber, silicone, polyisobutylenes, ethylene vinyl acetate, ethylene propylene rubber, ethylene propylene diene monomer rubber, polybutadiene rubber, natural rubber, polyisoprene rubber, butyl rubber, fluorocarbon rubber, and polyurethane.

16. The putty-like material of claim 12, wherein the gum elastomer has parts per weight ranging from 80 to 120 and the additive has parts per weight ranging from 1 to 60.

17. The putty-like material of claim 12, wherein the gum elastomer has a parts per weight ranging from 80 to 120 and the additive has a parts per weight ranging from 1 to 60.

18. The putty-like material of claim 12, said additive further comprising a reinforcing filler.

19. The putty-like material of claim 18, wherein the reinforcing filler has a parts per weight ranging from 1 to 60.

20. The putty-like material of claim 18, wherein the reinforcing filler is selected from the group consisting of talc, silica, clay, and fine particle (nanoparticle) mineral fillers.

21. The putty-like material of claim 12, said additive further comprising a viscosity modifying agent.

22. The putty-like material of claim 21, wherein the viscosity-modifying agent has a parts per weight ranging from 1 to 40.

23. The putty-like material of claim 21, wherein the viscosity modifying agent is selected from the group consisting of silicone oils, petrolatum, mineral oil, modified mineral oil, sulfonated mineral oil, paraffinic oil, and oils comprising any of phthalates, phosphates, and sebaceates.

24. The putty-like material of claim 12, wherein the additive comprises a fragrance selected from the group consisting of essential oils, natural and synthetic fragrances.

25. The putty-like material of claim 12, wherein the additive comprises an emollient selected from the group consisting of petrolatum, waxes, oils, fats, and alcohols.

26. A putty-like material having a consistency making it kneadable by a human hand, comprising:
80 to 120 part by weight of a gum elastomer selected from the group consisting of SBR, SEBR, silicone, PIB, EVA, EPR, EPDM, and polyurethane;
5 to 60 parts by weight of a reinforcing filler;
5 to 40 parts by weight of a viscosity modifying agent; and
5 to 10 parts by weight of an additive for transfer to the hand or skin.

27. A kneadable, putty-like material, comprising:
a polysiloxane-boron compound (bouncing putty) which exhibits sufficient elasticity to be kneaded or squeezed to release an agent dispersed within; and
said material further comprising a delivery system for said agent;
said agent comprising any of skin conditioners, emollients, moisturizers, and moisture barrier agents to a person's skin when said material is kneaded or squeezed by said person.

28. A kneadable, putty-like material, comprising:
a polysiloxane-boron compound (bouncing putty) which exhibits sufficient elasticity to be kneaded or squeezed to release an agent dispersed within; and
said material further comprising a delivery system for said agent;
said agent comprising any of petrolatum, dimethicone, shea butter, glycerin, lanolin and other emollients, moisturizers, and moisture barriers to a person's skin when said material is kneaded or squeezed by said person.

29. The material of claim 28, further comprising:
any of fragrances, antibacterial agents, and sunscreens.

30. A kneadable putty-like delivery system, comprising:
an elastic polymer of silicone, vinyl, cellulose, or other putty-like chemistry or combinations thereof into which one or more desired agents to be delivered are either miscible or can be blended within a material matrix in a range that delivers an appropriate quantity of said one or more desired agents, either individually or in combination to a person's hand.

31. The kneadable putty-like delivery system, of claim 30, wherein said material possesses kinematic viscosity in a range between 800K and 1,600K centistokes, and more preferably in a range between 1,000K and 1,400K centistokes.

32. The kneadable putty-like delivery system of claim 30, further comprising:
a filler material for increasing viscosity;
wherein said filler material is present in an amount of from 1% by weight to about 60% by weight based on 100% by weight of said material.

33. The kneadable putty-like delivery system of claim 32, wherein said filler material is selected from the group consisting of silica, talc, calcium carbonate, wood flour, titanium dioxide, cotton flock, clay, bentonite, zinc hydroxide, barium sulfate, and combinations thereof.

34. The kneadable putty-like delivery system of claim 30, further comprising:
a softener material for decreasing viscosity of the material;
wherein said softener is present in an amount of about 1% by weight to about 30% by weight based on 100% by weight of said material.

35. The kneadable putty-like delivery system of claim 34, wherein said softener material is selected from the group consisting of oleic acid, silicone oils, glyceryl oleate, and combinations thereof.

36. The kneadable putty-like delivery system of claim 30, wherein active agents comprising any of petrolatum, dimethicone, shea butter, glycerin, lanolin, and other emollients, moisturizers, and moisture barriers are present without any inactive ingredients or diluents normally found in lotions, creams, and liquids;
wherein a large quantity of an active agent is delivered within a small volume of said material.

37. The kneadable putty-like delivery system of claim 36, wherein a specific quantity of a desired agent or agents is delivered to the skin.

38. The kneadable putty-like delivery system of claim 37, wherein said material delivers the desired agents as a user continuously squeezes the material in her hand or rubs it on her skin.

39. The kneadable putty-like delivery system of claim 38, wherein an amount of the desired agent or agents delivered is based on an equilibrium point reached between a concentration of a desired agent in the material and the concentration of the agent on the user's skin.

40. The kneadable putty-like delivery system of claim 38, wherein only the active agent or agents are depleted as the puffy is squeezed or rubbed on the user's skin, and not the putty carrier.

41. The kneadable putty-like delivery system of claim 36, wherein amount of active agent required by the skin is only a small fraction of the total amount of agent dispersed within the material.

42. The kneadable putty-like delivery system of claim 36, wherein a change in a total percent concentration of agent in the material is only reduced by a small percentage as a result of user interaction therewith.

43. A kneadable, putty-like thermal delivery system, comprising:
a high viscosity matrix material, comprising a high-viscosity silicone gum, which exhibits sufficient elasticity to be kneaded or squeezed to release an agent dispersed within; and
said material further comprising a delivery system for said agent;
said agent comprising a phase change material (PCM) dispersed within said material for providing high heating or cooling capacity at various desired temperatures.

44. The system of claim 43, wherein said PCM is microencapsulated.

45. The system of claim 44, wherein said PCM comprises encapsulated particles in the 10 to 250 micron range.

46. The system of claim 44, wherein said encapsulated particles are not damaged during dispersion into said high viscosity matrix material.

47. The system of claim 44, further comprising any of graphite, aluminum, or iron oxide powder dispersed within said matrix for any of electrical and thermal conductivity.

48. The system of claim 47, wherein an agent having electrical conductivity is dispersed within said matrix to allow the matrix to be heated in a microwave oven.

49. The system of claim 47, wherein particle sizes for aluminum or graphite are generally in the 10-250 micron range.

50. The system of claim 44, wherein the microcapsules are broken as the matrix is kneaded;
wherein either of endothermic and exothermic reactions occur as microcapsules are broken;
wherein the matrix is either of self-heating or self-cooling.

51. The system of claim 50, wherein the amount of heat or cold released is a function of the vigor with which the matrix is squeezed.

52. The system of claim 44, the matrix further comprising:
a delivery system for any of perfumes, aromas, and other volatiles comprising any of camphor, peppermint, and eucalyptus oils, or other essential oils, natural oils, or synthetic fragrances.

53. The system of claim 44, wherein the matrix comprises a material that is intimately conformed to irregularly shaped body parts.

54. The system of claim 44, wherein the matrix is blended to have a viscosity that is softer when it is warm and becomes stiffer as it cools.

55. The system of claim 44, wherein the matrix is infused or mixed with any of antibacterial agents, aromas, emollients, conditioners, oils, capsaicin, and menthol for release during application of heat or cold.

56. The system of claim 44, said matrix comprising a material having a naturally adhesive property when in contact with a surface; wherein said system tends to stay in place when pressed against a body or other part.

57. The system of claim 44, further comprising:
microencapsulated ingredients dispersed within said matrix to cause either endothermic or exothermic reactions when encapsulation shells are broken during kneading by a user, a rate of reaction being controlled by the vigor of kneading.

58. The system of claim 44, further comprising:
a catalyst for curing said matrix.

59. The system of claim 44, further comprising:
a composite material, wherein two layers of matrix material are laminated; wherein a bottom layer contains no electrically conductive material or PCM's and wherein a top layer contains both PCMs and electrically conductive material.

60. The system of claim 44, further comprising:
a heat activation catalyst that can be flash-cured by application of heat on an outside surface of a formed matrix;
wherein an outer layer of the matrix becomes a container;
wherein a sealed container of any desired shape is created; and
wherein said matrix still has flexibility to conform to a body part or area of concern.
